(19) United States
(12) Patent Application Publication
(10) Pub. No.: US 2009/0019388 A1
(43) Pub. Date: Jan. 15, 2009

(54) Anti-virus usage model at an exterior panel of a computer

(76) Inventors: Lifeng Zhang, Shanghai (CN); Xiaofeng Sheng, Shanghai (CN); Ce Shi, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/591,362

(22) PCT Filed: Jul. 3, 2006
(86) PCT No.: PCT/CN06/01549

§ 371 Date: Sep. 1, 2006

(51) Int. Cl. G06F 3/00; G06F 21/00

(52) U.S. Cl. 715/772; 726/24

(57) ABSTRACT

An anti-virus usage model for a computing device includes a secondary display on an exterior panel of the computer device and a plurality of user buttons adjacent to the secondary display. The computing device may also include a virus indicator button on the exterior panel. The secondary display presents virus information of the computing device, and the user buttons receive commands from a user to perform anti-virus operations. The virus indicator button is integrated with a light-emitting diode (LED) to display different colors indicating different virus statuses. Thus, anti-virus information may be easily accessible and anti-virus operations may be easily performed.

### BACKGROUND

1. Field

A hardware user interface for anti-virus operations.

2. Background

Viruses present a serious threat to data integrity for the information stored on a computer. Current anti-virus software on the market generally does not have a standardized user interface or usage model for anti-virus operations. Unsophisticated users sometimes find it difficult to operate the anti-virus software or know the status of the anti-virus software on their computers.

Moreover, current anti-virus software mostly uses pop-up windows to interact with the users. These pop-up windows often interrupt the ongoing work or entertainment engaged by the users. Further, when a computer system is infected by virus, its display may also be inflected and fail to pop up warning messages. The computer system may even stop taking input from the keyboard or mouse, thus render it unable to receive any user commands.

### BRIEF DESCRIPTION OF THE DRAWINGS

Embodiments are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 shows a front view of an embodiment of a computer having a virus indicator button, a secondary display, and user buttons on a front panel.

FIG. 2 shows a block diagram of an embodiment of a system comprising the computer of FIG. 1.

FIG. 3A-FIG. 3D show examples of information presented on the secondary display.

FIG. 4A-FIG. 4B show examples of options presented on the secondary display.

FIG. 5 is a flow chart showing an embodiment of anti-virus operations.

### DETAILED DESCRIPTION

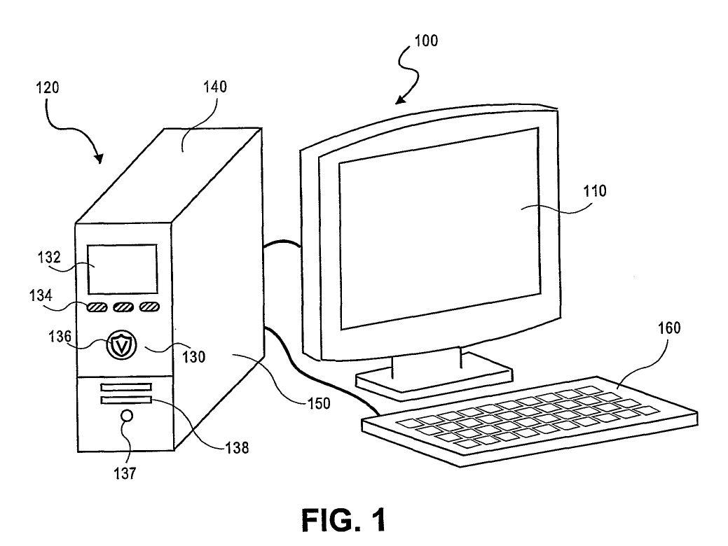

FIG. 1 is a front view of an embodiment of a computer 100 including a computing module 120 connected to a main display 110 and a keyboard 160. Computing module 120 is enclosed by exterior panels that include a front panel 130, a top panel 140, and side panels 150. In the embodiment as shown, front panel 130 include a secondary display 132, a plurality of user buttons 134 adjacent to (e.g., below) secondary display 132, a virus indicator button 136, as well as a power button 137 and disk insertion slots 138. In an alternative embodiment, one or more of the components shown on front panel 130 may reside on any of the exterior panels (e.g., a top panel 140 or side panels 150) of computing module 120.

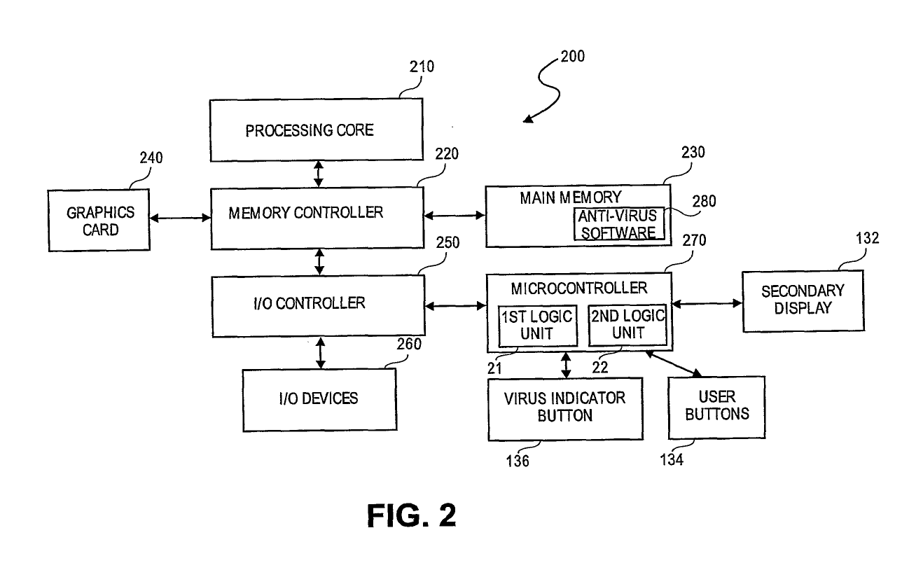

FIG. 2 is a block diagram showing an embodiment of a system 200 comprising computer 100 (FIG. 1). System 200 includes at least one processing cores 210 coupled to a memory controller 220. Memory controller 220 may provide an interface for the components of system 200 to access main memory 230, graphic cards 240, and other memory devices. Memory controller 220 and processing core 210 may be located on the same chip or on separate chips. Main memory 230 may comprise one or more types of memory such as, for example, dynamic random access memory (DRAM) devices, synchronous dynamic random access memory (SDRAM) devices, double data rate (DDR) SDRAM devices, dual in-line memory modules (DIMMs), or other volatile memory devices. Other memory devices may comprise flash memory, DRAM devices, read-only memory (ROM), or any volatile or non-volatile memory devices.

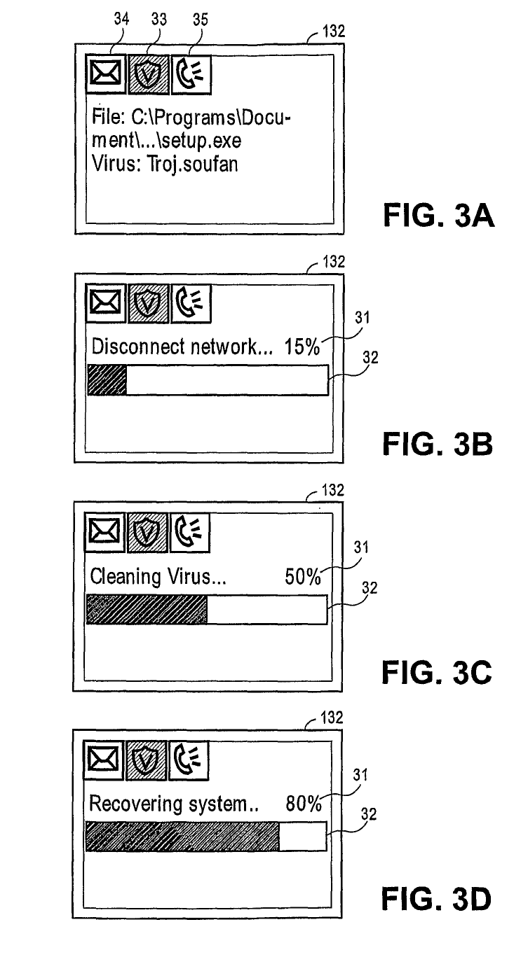

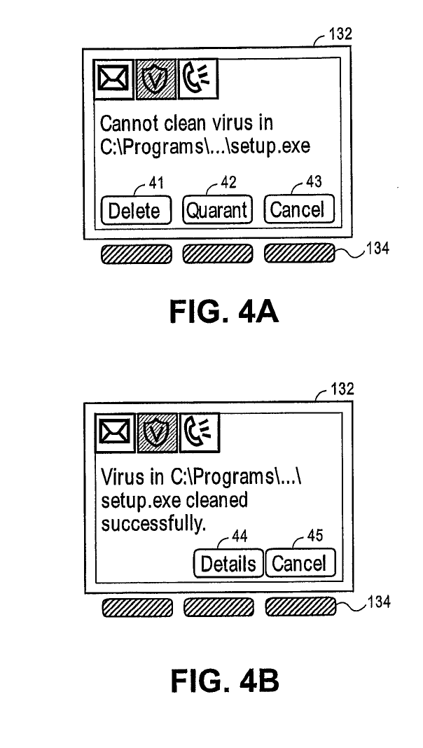

System 200 may include an input/output (I/O) controller 250 coupled to memory controller 220. I/O controller 250 may provide an interface for the components of system 200 to access I/O devices 260. I/O devices 260 may include Industry Standard Architecture (ISA) devices, Peripheral Component Interconnect (PCI) devices, PCI Express devices, Universal Serial Bus (USB) devices, Small Computer System Interface (SCSI) devices, or other standard or proprietary I/O devices suitable for server or general applications. In one embodiment, I/O devices 260 may include main display 110 and keyboard 160 of FIG. 1. I/O controller 250 may also connect to a microcontroller 270 that includes a first logic unit 21 and a second logic unit 22. Logic units 21 and 22 control the operations of secondary display 132, user buttons 134, and virus indicator button 136 of FIG. 1. The functions of logic units 21 and 22 will be described in detail with reference to FIGS. 3A-3D and FIGS. 4A-4B.

In one embodiment, main memory 230 may store a copy of anti-virus software 280. Anti-virus software 280 may include anti-virus code and its associated database. Processing core 210 may check the status of anti-virus software 280 and executes the software according to a pre-defined schedule or at an occurrence of a pre-defined event, e.g., during boot-up. As a result, processing core 210 may detect that anti-virus software 280 is out-of-date. Alternatively, processing core 210 may detect the presence of a virus. When processing core 210 detects either of the above events, processing core 210 may instruct microcontroller 270 to alert a user via secondary display 132 and virus indicator button 136 of FIG. 1

Virus indicator button 136 may be implemented by a light-emitting diode (LED) that lights up when an alerting event occurs. Virus indicator button 136 may indicates different virus status with different colors. In one embodiment, virus indicator button 136 may be a pressable button. In alternative embodiments, virus indicator button 136 may be activated by a user by any other suitable mechanisms. Virus indicator button 136 may be integrated with a two-state LED that lights up in red when the presence of a virus on computer 100 is detected. Virus indicator button 136 may light up in yellow when anti-virus software 280 is out-of-date. Pressing virus indicator button 136 when it is red triggers processing core 210 to clean the detected virus. During the virus cleaning process, processing core 210 may report its working process to the user on secondary display 132. Pressing virus indicator button 136 when it is yellow triggers processing core 210 to search for the latest patch for anti-virus software 280. When the latest patch is found, processing core 210 may apply the patch to update software 280. The LED light of virus indicator button 136 is off after the virus is cleaned up or software 280 is updated. If the user presses virus indicator button 136 when the LED light is off, a regular hard disk virus scan may be performed. Although red and yellow are disclosed as the color of the two-state LED, it is understood that any other colors may be used to indicate different virus status.

In one embodiment, secondary display 132 may be implemented by a liquid crystal module (LCM), a light emitting diode (LED) display, or any other suitable display mechanisms. Secondary display 132 may present virus information to the user, thus avoiding popping up dialog windows on main display 110. Using secondary display 132 also avoids interruptions to the user's ongoing work on main display 110. Moreover, as there are no software windows on secondary display 132 to cover the virus information, messages on secondary display 132 catch the user's attention more easily than those on main display 110. Unlike conventional I/O devices which are typically susceptible to virus attacks, the virus that inflects conventional I/O devices does not usually affect the separate anti-virus hardware (e.g., microcontroller 270, secondary display 132, user buttons 134, and virus indicator button 136). Thus, the virus usage model described herein is more robust than a conventional software user interface.

Referring also to FIG. 3A, when processing core 210 detects the presence of a virus, virus indicator button 136 turns red and virus information is displayed on secondary display 132 to describe the virus type, infected files, or other relevant information. A virus icon 33 on secondary display 132 may be highlighted to show that anti-virus information is being displayed. After the user presses red virus indicator button 136, processing core 210 starts a sequence of anti-virus operations to remove the virus. The anti-virus operations may include, but are not limited to, disconnecting the network on which computer 100 is located to prevent the spread of virus, removing the virus, and recovering the system. Microcontroller 270 (FIG. 2) may include first logic unit 21 to present the progress of anti-virus operations on secondary display 132. Referring to FIG. 3B, FIG. 3C, and FIG. 3D, secondary display 132 may display a message 31 reporting the anti-virus operation currently being performed, as well as a completion percentage indicator 32 showing the working progress of the anti-virus operation.

In some scenarios, user intervention may be requested to proceed with the anti-virus operation. For example, the user may be requested to determine whether an infected file should be deleted. In one embodiment, microcontroller 270 (FIG. 2) may include second logic unit 22 to present at least one option on secondary display 132 for the user. Referring to FIG. 4A, secondary display 132 may present the request for user intervention with a number of options. Each of the options may be shown adjacent to one of user buttons 134. Secondary display 132 may inform the user that the virus in the file setup.exe cannot be cleaned up. Secondary display 132 may provide the user with three options: delete the file 41, quarantine the file 42, or cancel the virus removal operation 43. The user may respond by pressing the corresponding user button 134 located below the desired option. The response of the user may be forwarded to processing core 210 (FIG. 2) to perform the selected operation.

Secondary display 132 may continue to present other virus information and requests until the virus is finally cleaned up from the entire system. Referring to FIG. 4B, when the virus is successfully removed from the system, the user may press user button 134 below an option “details” 44 to request more detailed information, or press user button 134 below an option “cancel” 45 to clear screen or, in some scenarios, to return to a previous unfinished operation.

In addition to virus information, secondary display 132 may be used as a user interface for other system activities that may be of interest to the user. Referring back to FIG. 3A, for example, secondary display 132 may include an email icon 34 and a phone icon 35 in addition to virus icon 33. One or more of icons 33, 34, and 35 may be highlighted to indicate an associated activity as needing the user's attention. In one embodiment, email icon 34 may be highlighted to show the arrival of a new email message, and phone icon 35 may be highlighted to request the user's attention to messaging applications. Secondary display 132 may include additional icons as needed to facilitate the user's interaction with the system.

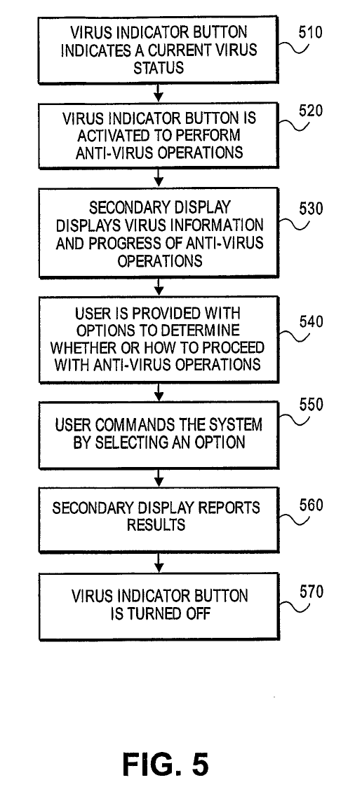

FIG. 5 is a flowchart showing an example of anti-virus operations according to the anti-virus usage model described above. Referring also to FIG. 1, at block 510, virus indicator button 136 indicates a current virus status. At block 520, virus indicator button 136 may be activated by a user to perform anti-virus operations according to the current virus status. At block 530, secondary display 132 may display virus information and working progress of the anti-virus operations. At block 540, user intervention may be requested. Secondary display 132 may show messages and provide options for the user to determine whether or how to proceed with the anti-virus operations. At block 550, the user may command the system by selecting a desired option. At block 560, secondary display 132 may report the result of the anti-virus operations. At block 570, virus indicator button 136 is turned off.

Computing systems that may use the above anti-virus usage module may include personal desktop/laptop computers, servers, personal digital assistants, network processors, or any other suitable wired or wireless systems.

In the foregoing specification, specific embodiments have been described. It will, however, be evident that various modifications and changes can be made thereto without departing from the broader spirit and scope of the appended claims. The specification and drawings are, accordingly, to be regarded in an illustrative rather than a restrictive sense.

What is claimed is:

1. A method comprising:
presenting virus information of a computing device on an exterior panel of the computing device; and
receiving commands from the exterior panel to perform anti-virus operations.

2. The method of claim 1 wherein receiving commands comprises:
presenting at least one option on a display module located on the exterior panel.

3. The method of claim 1 wherein presenting virus information comprises:
displaying progress of the anti-virus operations on a display module located on the exterior panel.

4. The method of claim 1 wherein presenting virus information further comprises:
providing a virus indicator button on the exterior panel to indicate a virus status of the computing device.

5. The method of claim 4 wherein providing a virus indicator button comprises:
indicating a presence of a virus on the computing device.

6. The method of claim 4 wherein providing a virus indicator button further comprises:
indicating anti-virus software on the computing device as out-of-date.

7. The method of claim 4 wherein providing a virus indicator button further comprises:
activating the virus indicator button to trigger the anti-virus operations.

8. The method of claim 1 further comprising:
highlighting an icon on a display module at the exterior panel to indicate an associated activity as needing attention.

9. An apparatus comprising:
a display module on an exterior panel to present virus information of the computing device; and
a plurality of user buttons adjacent to the display module to receive commands to perform anti-virus operations.

10. The apparatus of claim 9 further comprising:
a virus indicator button on the exterior panel to indicate a virus status of the computing device and to trigger the anti-virus operations when activated.

11. The apparatus of claim 10 wherein the virus indicator button comprises:
a light-emitting diode (LED) to display a first color to indicate a presence of virus on the computing device and a second color to indicate anti-virus software on the computing device as out-of-date.

12. The apparatus of claim 9 wherein the display module comprises:
a liquid-crystal module (LCM).

13. The apparatus of claim 9 further comprises:
a microcontroller including a first logic unit to display progress of the anti-virus operations on the display module.

14. The apparatus of claim 9 further comprising:
a microcontroller including a second logic unit to display at least one option on the display module, wherein the displayed option is positioned adjacent to one of the user buttons.

15. A system comprising:
a main display;
a computing device coupled to the main display, wherein the personal computing device includes:
a liquid-crystal module (LCM) display on an exterior panel of the computing device to present virus information; and
a plurality of user buttons adjacent to the LCM display to receive commands to perform anti-virus operations.

16. The system of claim 15 further comprising:
a virus indicator button on the exterior panel to indicate a virus status of the computing device and to trigger the anti-virus operations when the virus indicator button is activated.

17. The system of claim 16 wherein the virus indicator button comprises:
a light-emitting diode (LED) to display a first color to indicate a presence of virus on the computing device and a second color to indicate anti-virus software on the computing device as out-of-date.

18. The system of claim 15 further comprising:
a processing core to execute anti-virus software and to cause the virus information to be presented on the LCM display.

19. The system of claim 15 further comprising:
a microcontroller including a first logic unit to display progress of the anti-virus operations on the LCM display.

20. The system of claim 15 further comprising:
a microcontroller including a second logic unit to display at least one option on the LCM display, wherein the displayed option is positioned adjacent to one of the user buttons.
